(19) United States
(12) Patent Application Publication
(10) Pub. No.: US 2008/0131825 A1
(43) Pub. Date: Jun. 5, 2008

(54) Candle reshaper

(76) Inventors: Marleen Falle, (US); Dave Falle, (US)

Correspondence Address: Global Intellectual Strategies, Unit 101, 120 Iber Road, Sttittsville, ON, K2S 1E9, omitted

(21) Appl. No.: 11/979,853

(22) Filed: Nov. 9, 2007

Related U.S. Application Data
(63) Continuation of application No. 10/547,502, filed on Aug. 31, 2005, now abandoned.

(30) Foreign Application Priority Data
Mar. 3, 2003 (CA) 2,422,409

(51) Int. Cl. F21V 3/02; B28B 21/98; F23D 3/16; F23Q 25/00

(52) U.S. Cl. 431/126; 425/392; 431/292; 431/146

(57) ABSTRACT

A candle top and reshaper fit snuggly over a candle. The reshaper includes interior and straight tapered, curved or otherwise angled sidewalls that when fitted over a burning candle, the softened candle rim and sides are forced back into the center of the candle, causing the softened rim to reshape and prolong the candle burn time. Alternatively the walls of the reshaper are vertical and force the softened sides and rim down and into the center. The reshaper also protects the softened and liquefied wax of the candle from dirt and insects during the re-cooling process and the top provides a decorative cover when candles are stored.

### CROSS-REFERENCE TO RELATED APPLICATIONS

This application claims benefit of the Canadian priority application, number 2,422,409 filed Mar. 3, 2003. This is a continuation of U.S. application Ser. No. 10/547,502 filed Aug. 31, 2005.

### MICROFICHE APPENDIX

Not applicable.

### FIELD OF INVENTION

This invention relates in general to a candle cover or assembly and, in particular, to a candle reshaper to reshape the soft sides of a candle after burning.

### BACKGROUND OF THE INVENTION

Anyone who has burnt a pillar candle, of any size or shape, will understand that the area surrounding the wick evaporates more quickly than the area away from it. After repeated uses or a long burning time, the area surrounding the wick burns deeper and deeper into the candle, possibly drowning the wick in too much melted wax or becoming too deep to comfortably light. At this stage it is common to throw out the candle or a portion of it, long before the expiration of the recommended burning hours.

As the wick burns deeper into the candle the light emitting from the candle is less bright and may be considered less attractive. Further, as a candle burns, the rim at the top of the candle becomes irregularly shaped, with some portions higher and thicker than others and the appearance of the candle is degraded. The larger the diameter of a candle the more this process is aggravated.

To minimize this effect and to prolong the candle burn time, candle experts advise candle owners to reshape the softened candle edges by pressing the softened rim toward the center of the candle, melting more of the area near the edge so as to make use of all the wax and render the top rim of the candle almost flat. This is to be done immediately upon extinguishing the flame of a candle and even during the burning of a candle. Reshaping a candle requires skill and patience and usually results in an uneven rim, unless the person reshaping the candle takes a great deal of care.

Certain candle manufacturers have tried to minimize the effect of burning a small central portion of a larger candle by incorporating a wick that separates and burns as two or more larger balls. The heat added from the balls of wick permits larger diameter areas to soften and liquefy. Although the burn time of the candle is prolonged somewhat, the softened wax at the rim is not added to the liquefied wax providing for even longer burning. Further this type of wick may cause the candle to smoke.

Another factor degrading the appearance of the candle is trapped dirt, such as dust and insects. Candles left uncovered after extinguishing, and as the melted wax is cooled, frequently trap such substances leaving the appearance of the candle undesirable.

When moving a still warm candle, it is not uncommon for liquid wax to spill and burn the person moving the candle or to drip on a cloth or rug or even electronic equipment. Clean up of wax from most textiles, and certainly from rugs, is a long process and often the wax colour or dye cannot be completely removed.

The candle top cover of U.S. Design Pat. DES. 425,636, issued May 23, 2000 to Scott Freeman provides for a candle cover and is shown used over a candle. This design hides the top of a candle and therefore the effects of burning the candle; further this design prevents the liquefied wax from collecting dust and insects but it does not lengthen the burn time of the candle or improve the burning of the candle. In addition, there is no evidence that this design prevents spilling of liquefied wax when moving a candle.

Although the above solutions addressed some of the issues associated with the burning of a candle, they do not provide a combined solution to the decreased burning time of a candle, improving the appearance of the candle during the burning time and covering the candle between uses. Also none provided a simple tool for reshaping a candle.

### SUMMARY OF THE INVENTION

It is therefore an object of the present invention to provide a candle reshaping tool to reshape the softened sides and rim of a candle providing for a longer candle burn time.

Another object of the present invention is to provide a candle top that will attractively cover a candle between uses.

Yet another object of the present invention is to provide a candle cover that forms a seal with the candle and allows the candle to be moved immediately after extinguishing, despite the presence of liquefied wax.

Therefore, in accordance with the present invention there is provided a candle reshaper for reshaping the heat softened wax at the rim of a candle. The candle reshaper comprises a body having one or more sidewalls and a top, the sidewall and top defining a hollow for receiving the candle. The candle having a spatial dimension or size and shape. The spatial dimension or size is defined as the candle's diameter or perimeter. The top includes a substantially flat perimeter portion that meets the candle's softened rim when the reshaper is placed over the candle and downward pressured is applied, forcing the softened wax downward and inward toward the wick.

In accordance with another aspect of the present invention the body may further include first and second opposing ends, the second end having a larger diameter than the first end and a size substantially similar to the size of the candle. This provides for the sidewall to be angled outward from the hollow in either a straight taper or convex or concave angle. In one instance the angled sidewall will meet the candle's softened rim prior to the top and force the softened wax inward toward the wick or wicks. When the top meets the candle's softened rim it will force the wax downward and toward the wick. In another instance the top will not meet the softened rim and so the softened wax will be forced only inward by the sidewall.

In accordance with another aspect of the present invention the body may otherwise include a proximal end near the top and a distal end away from the top. The distal end having a dimension substantially similar to the dimension of the candle and the proximal end having a dimension somewhat smaller than the diameter of the candle.

In accordance with another aspect of the present invention a single sidewall is required to define a hollow, if the shape of the candle is round. Alternatively, three sidewalls are required for a triangular shaped candle and four sidewalls are required for a square shaped candle.

In accordance with yet another aspect of the present invention a decorative assembly for a candle is provided. The decorative assembly comprises a housing member having at least one side, the at least one side defining a hollow; a lid member, the lid member having a central portion and fitting on top of the housing member, to substantially cover the housing member; and securing means to secure the lid member to the housing member. This decorative assembly is placed over a candle when the candle is not in use to provide a decorative and pleasing effect.

In accordance with yet another aspect of the present invention the decorative assembly further includes a reshaper for reshaping the softened wax at the rim of a candle.

In accordance with another aspect of the present invention the decorative assembly is used in conjunction with a decorative base assembly.

In accordance with a further aspect of the present invention a liquefied wax protective cover for a candle is provided. The protective cover comprises a body including at least one sidewall and a top, the sidewall and top defining a hollow; the body shaped to accept the candle within the hollow and the body further having a perimeter substantially similar to the perimeter of the candle. In this instance when the body is placed over the candle, the at least one sidewall or the top contacts the softened rim of the candle and forms a seal, sealing in the liquefied wax and permitting the candle to be moved immediately after extinguishing.

In yet another aspect of the present invention the protective cover further includes a lid member, the lid member fitting on top of the body, to substantially cover the body; and securing means for securing the lid member to the body. The lid member providing additional protection during handling of the protective cover wherein the lid member may easily be handled even when the body is warmed by the warm candle wax.

An advantage of the present invention is that the candle burn time is increased. When the reshaper forces the softened wax toward the wick, additional wax is introduced for consumption by the flame.

Another advantage of the present invention is that an attractive appearance is returned to a candle after burning.

Another advantage of the present invention is that the candle may be displayed, after burning with a decorated top and base, providing an appealing and decorative effect.

Yet another advantage of the present invention is that the candle cover or reshaper will form a seal, when applied over the candle, with the softened rim of the candle and seal the liquefied wax within. This permits handling of the candle immediately after extinguishing. It also protects curious children from the hot wax.

And yet another advantage of the present invention is that the candle is extinguished when the cover or reshaper is put over the candle. In this manner liquid wax is not blown past the candle as can happen when a candle is put out by blowing on it.

### BRIEF DESCRIPTION OF THE DRAWINGS

FIG. 1 is a side view of the candle top and base assembly, in use, where the candle top assembly is slightly removed from the candle top to expose the reshaped candle rim and wick.

FIG. 2A is an exploded view of the candle top assembly, of the present invention, depicting the many components.

FIG. 2B is a side view of the candle top assembly while FIG. 2C is a cross-sectional view through section A-A of FIG. 2B, exposing the candle reshaper of the present invention.

FIGS. 3A, 3B and 3C are multi-view diagrams of the candle reshaper of the preferred embodiment of the present invention.

FIG. 4A is a side view of the candle reshaper of the preferred embodiment of the present invention

FIG. 4B is a cross-sectional view, through section B-B, of the candle reshaper of FIG. 4A and provides typical dimensions of the reshaper of the preferred embodiment of the present invention.

FIG. 4C is a magnified view of section C of the candle reshaper of FIG. 4B.

FIGS. 5A, 5B and 5C are multi-view diagrams of the decorative reshaper housing of the candle top assembly of the preferred embodiment of the present invention.

FIG. 6A is a side view of the lid portion of the candle top assembly of the preferred embodiment of the present invention.

FIG. 6B is a cross-sectional view through section A-A of FIG. 6A, and provides typical dimensions of the lid of the preferred embodiment of the present invention.

FIGS. 7A, 7B and 7C are multi-view diagrams of the optional candle base assembly.

### DETAILED DESCRIPTION OF THE PREFERRED EMBODIMENT

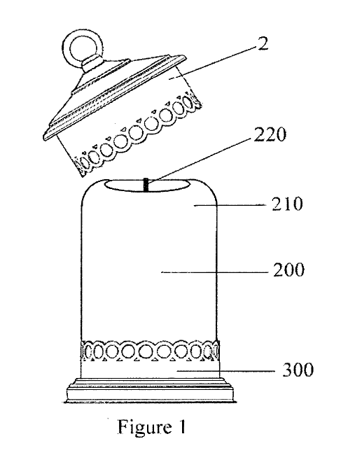

Referring to FIG. 1, there is depicted a candle top assembly 2 held above a candle 200. The candle 200 sits in an optional candle base 300. Together, candle top assembly 2, when placed over the candle, and candle base assembly 300 provide for a decorative display of the candle 200 when the candle 200 is not in use, for example when the candle is not burning. The contour of the rim 210 of candle 200 is such that the rim has been reshaped by the candle top assembly 100. The wick 220 of the candle 200 is visible in the center and at the top of the candle 200. When burning the candle, the candle top assembly 2 is removed and the wick is lit. The candle may sit in the optional base assembly 300 during burning. Recommended burning duration for a three-inch diameter pillar candle, such as depicted in FIG. 1, is three hours every time the candle is lit. The burn time of a candle is influenced by the type of wax used, be it bees wax, paraffin wax or soy wax, and also by the quality of the wax selected. The average burning time of a six-inch high, three-inch diameter pillar candle, such as depicted in FIG. 1, should burn between 80 and 120 hours providing proper care and burning of the candle is taken.

When a burning candle's wick is below the top surface and surrounded by liquefied wax and the candle sides have softened it is desirable to reshape the candle so as to prolong the candle's burn time. Reshaping pushes softened wax, closer to the center of the candle, inward into the liquefied wax and close to the wick. The softened wax pushed into the liquefied wax becomes available for burning and prolongs the burn time of the candle. If a candle is not reshaped, a narrow pool of liquefied wax is formed close to the wick and only this liquefied wax burns off. The wick may drown in the liquefied wax formed in the narrow opening. Also, candles typically burn unevenly resulting in an irregularly shaped rim with higher and lower portions.

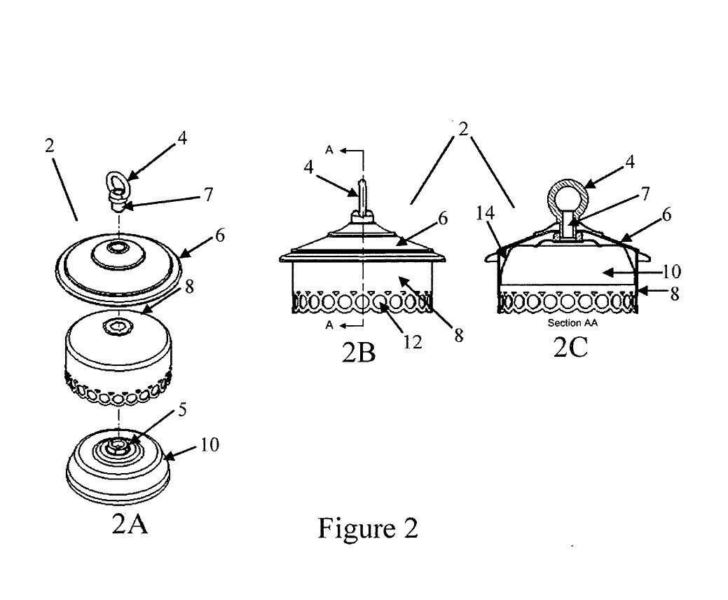

FIGS. 2 to 6 depict the components of the preferred embodiment of the candle top assembly 2. Although only the reshaper 10 is necessary to reshape the candle rim, the other components provide for a decorative finish and surrounding to the reshaper 10. In other words, the reshaper 10 performs the function of reshaping the softened rim of a candle while the other components provide beauty when the candle top assembly 2 is left on a candle not in use or not burning.

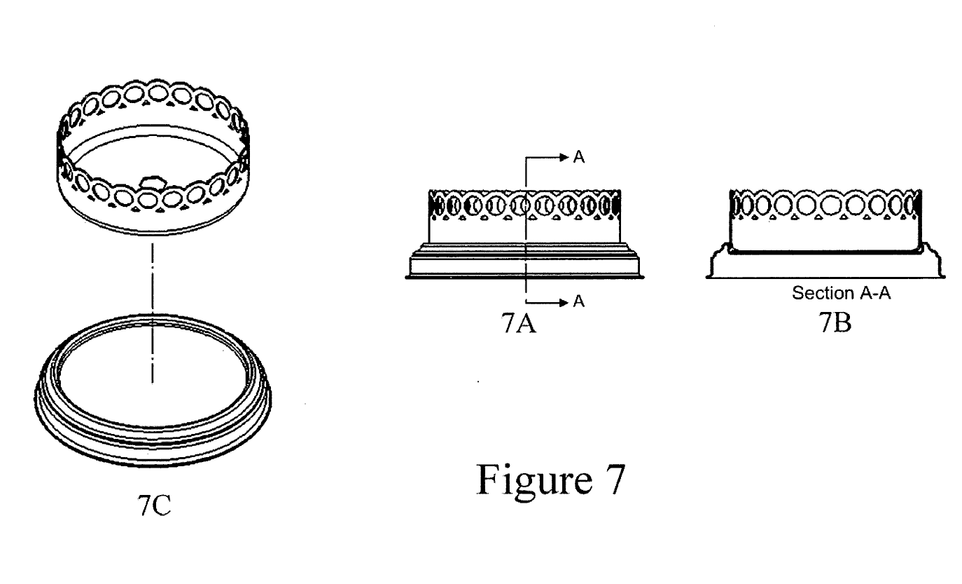

FIG. 7 depicts the components of the optional candle base assembly 300. Again, the components provide decorative detail to the base assembly 300 that matches the decorative detail of the candle top assembly 2. Any other base design or no base may be used.

FIGS. 2A through 2C depict various views of the candle top assembly 2 of the preferred embodiment. Although, in this example, the candle top assembly is round, it may be of various shapes and sizes to fit the various candles available in today's markets. The candle top assembly 2 includes a candle reshaper 10, for reshaping the heat softened rim of a candle; a decorative reshaper housing 8, for fitting over a candle 200; a lid 6, which covers the top of the decorative housing; and optionally includes a finial 4 for facilitating the removal of the candle top assembly 2 from the candle.

Referring to specifically FIG. 2A, centrally located and welded to the top of reshaper 10 is threaded securing nut 5. While finial 4 includes a threaded post 7, the post inserts into central openings in the lid 6 and decorative housing 8 and is used for threading into the securing nut 5. In this manner, the various components of the candle top assembly 2, including the reshaper 10, decorative housing 8, lid 6 and optional finial 4 are secured together. Of course, other means for removably joining the components, such as a bolt, clamp or fitted lock may be used. As well, means for permanently joining the components, such as welds or epoxies, may also be used. Each component may be removably or permanently joined to the other components. The manner of joining is not to be limited by the method depicted in the preferred embodiment supported by the figures.

The optional finial 4 may be of any suitable shape and may be joined to the lid 6 or reshaper 10 in any other suitable manner, such as welded or glued. The finial 4 adds decorative appeal to the candle top assembly 2 and also facilitates the removal of the top assembly 2 from a candle. To further enhance appeal, the optional finial 4 may be of various designs, such as suitable for a season, a leaf for fall, a sun for summer, snowflake for winter and so on, and may be interchangeable if joined in a removable fashion.

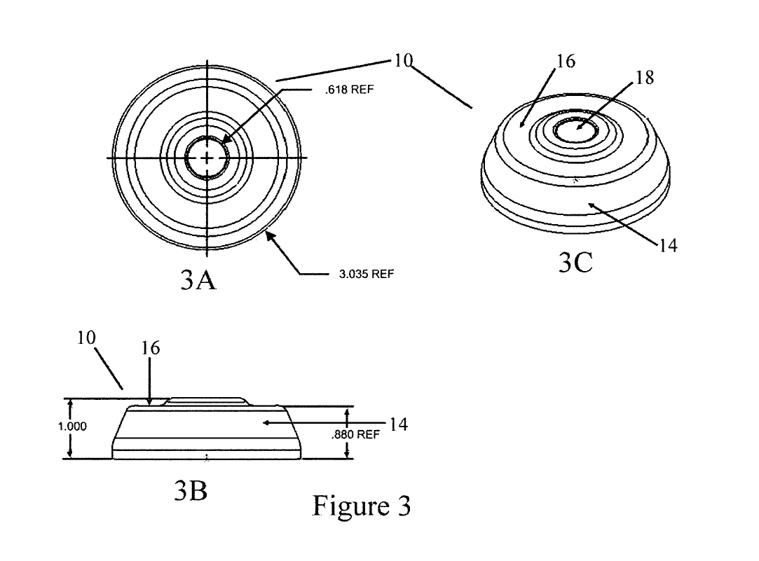

For prolonging the burning time of a candle the only necessary component of the candle top assembly 2 is the reshaper 10. A candle reshaper 10, shown in FIGS. 2A and 2C and FIGS. 3 and 4, fits inside the decorative reshaper housing 8. For proper reshaping of the candle, in order to extend the candle burn time and restore an attractive, smooth and even rim, the softened sides of the candle must be forced inward and then downward pushing the soft wax at the rim 210 into the center and then downward; basically folding the soft wax into itself and towards the center. To accomplish this, it is important for the sidewalls 14 of the reshaper 10, seen in FIGS. 2C and 3B, to contact the candle rim 210 before the top 16 of the reshaper does. Hence, the reshaper top 16 is to have a diameter dimension somewhat less than the diameter dimension of the candle. For preferable results, the diameter of the reshaper top 16 is to be between five to eighteen percent less than the diameter of the candle. This range allows for variations in the size of candles of the same group. For example, three inch round candles vary in size and are rarely exactly three inches in diameter.

Where the diameter of the reshaper top 16 is notably smaller than 15 percent of the candle diameter, the softened wax at the candle rim 210 will be forced inward only and not downward as the reshaper top 16 will not meet the candle top. In this instance additional wax will be provided to the center, for increasing burning time, but the top of the rim may not be smoothed and evened out. Depending on the severity of the unevenness of the rim, this will affect the attractiveness of the candle.

Another method to extend the candle burn time, and not necessarily to restore beauty, is to force the softened rim of the candle downward and into the center. This is accomplished by a reshaper 10 having vertical sidewall 14 providing no angle, taper or curve. The vertical sidewall 14 being perpendicular to the top 16. The diameter of the reshaper must be substantially similar and preferably no larger than approximately five percent of the candle diameter. A reshaper diameter larger than ten percent of the candle diameter will be less effective. As the reshaper has a similar diameter as the candle, the softened wax is forced downward and, as the wax cannot move outward due to the reshaper sidewall 14, the wax moves towards the wick 220 providing more wax in the proximity of the wick. The additional wax will lengthen the burn time of the candle but as softened wax will ooze to the outside of the candle, as much as the reshaper sidewall will allow, the attractiveness of the candle may be diminished.

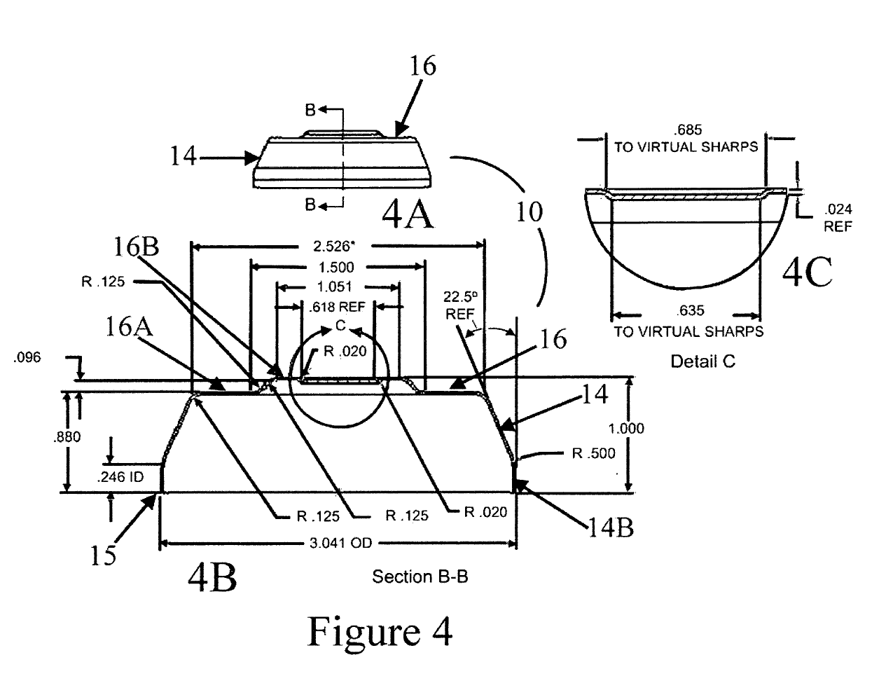

The reshaper 10 of the preferred embodiment is depicted clearly in FIGS. 3 and 4. As seen in FIG. 4B the reshaper 10 is designed to fit over a three inch candle. The reshaper 10 includes a hollow body defined by annular sidewall 14 and reshaper top 16. The annular sidewall 14 is angled outward, away from the center of the hollow, forming an increasingly larger diameter and perimeter towards the distal end 15 of the sidewall 14. The diameter at the distal end is slightly more than three-inch candles, available on the market, and is preferably approximately 3.041 inches. The angle may be a straight taper or a curved taper providing either a concave or convex shape to the annular sidewall 14. As further seen in FIG. 4B, distal section 14B of reshaper sidewall 14 bends inward to a vertical alignment. The 14B section provides for a stronger distal end 15 to the hollow body. A centrally located and elevated portion 16B of reshaper top 16 includes an aperture 18, seen in FIG. 3C, for receiving the securing nut 5, seen in FIG. 2A. The elevated portion 16B defines the location of the reshaper 10 in relation to the lid 6, when the components of the top assembly 2 are secured together with the securing nut 5. The outer perimeter portion 16A of the reshaper top 16 is substantially flat and is the portion that contacts the top of the candle rim 220 when the diameter of the reshaper top 16 is sufficiently large to permit it.

For prolonging the burning time of a candle the only necessary portion of the reshaper 10, is the sidewall 14. The angle or taper of the sidewall provides for contacting the rim of a candle at various locations along the taper, depending on the diameter size of the candle. The sidewall 14 applies pressure to the softened wax at the rim 210 of the candle 200 and forces the wax inward towards the central wick 220. For this purpose the top 16 is not a necessary portion of the reshaper 10. If restoring an attractive smooth and even rim is desirable then a top with a diameter size somewhat less than the candle is needed. For this purpose the reshaper top 16 will contact the top of the rim 210 of the candle and force the irregular wax downward forming a smooth surface.

Alternative reshaper 10 will have a sidewall 14 perpendicular to the reshaper top 16 with an overall diameter size of approximately 3.041 and not more than ten percent wider than the candle diameter. As the walls are vertical, the top diameter size of the reshaper top 16 is substantially similar to the diameter size at the distal end 15 of the reshaper sidewall 14.

The preferred embodiment depicted in the figures is that for reshaping a round shape pillar candle of three-inch diameter size and only a single sidewall 14 is described. Other embodiments may be shaped for any candle presently available on the market. For example a triangular shaped candle will require three reshaper sidewalls, while a square candle will require four reshaper sidewalls.

The reshaper 10 is preferably made from a single piece of material and shaped. The sidewalls 14 of the reshaper 10 are preferably tapered or curved or alternatively shaped so as to touch and reshape the sides of the candle 200 preferably before the reshaper top 16 contacts the rim 210 of the candle 200. Alternatively, the reshaper 10 may have vertical sidewalls where the vertical sidewalls prevent the softened wax from oozing substantially away from the original shape.

The sidewalls 14 of the reshaper 10 may have the same concentric shape as the candle, for example a round reshaper for a round candle, or alternatively, may be shaped such as to provide a different shape to the softened wax of the rim. For example a star shaped reshaper will reshape the softened rim of a round candle to that of a star. Also an impression, such as a logo, trade mark, artistic impression or message, may be printed in the reshaper so as to impart the same impression into the softened wax. For example the words HAPPY BIRTHDAY may be shaped into the softened wax when the reshaper is pressed to it.

In the embodiment depicted in the figures, the candle top assembly 2, including reshaper 10 are shaped for a three-inch round candle. The components of the top assembly 2, including reshaper 10, may be made of rod iron, aluminum, stainless steel, other metal, painted or not, painted and natural ceramic, plastic, wood, stiffened cloth or any other suitable material. The material used may be nickel, chrome or brass plated or finished with a lacquer to prevent tarnishing and corroding. The reshaper 10 and each of the other components of the top assembly 2 may be made of different materials.

Optionally the lid 6 or decorative housing 8 of the top assembly 2 may be decorated with any motif or design 12, such as shown in FIG. 2B. The design or motif may be made from a laser such as an engraving; tooled for punching out the motif or providing relief to the surface; silk screened; etched or alternatively decals may be applied. The design or motif is not limited to what is shown in the figures herein incorporated. The finial 4 and lid 6 may also be complementarily shaped and decorated to represent themes such as Santa's or a Witch's hat.

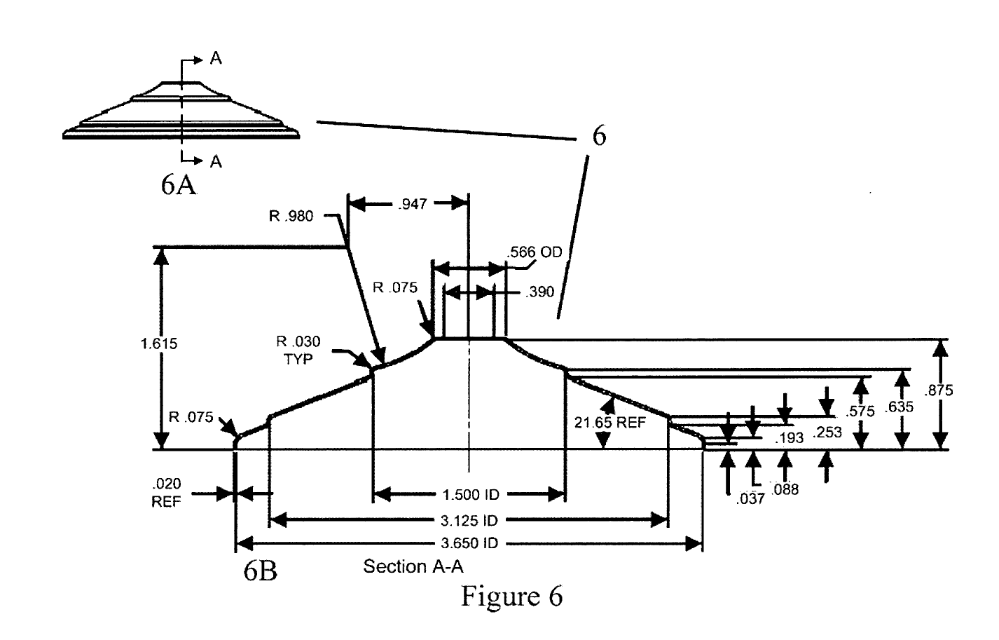

For proper reshaping of a candle, such as candle 200, the lid 6 is not a necessary component of the candle top assembly 2. In the preferred embodiment, the lid 6 is added purely for decorative purposes. FIG. 6A shows the lid 6 having a decorative multi-layered design. It is to be understood that the lid may have a smooth layer or be otherwise shaped. FIG. 6 provides dimensional information of the lid 6 of the preferred embodiment.

Also for proper reshaping of a candle, such as candle 200, the decorative reshaper housing 8 is not a necessary component of the candle top assembly 2. In the preferred embodiment, the decorative housing 8 is also added purely for decorative purposes.

To one skilled in the art, it is obvious that the candle top assembly 2 may be punched from a single piece of material and shaped into a candle top and reshaper unit that will reshape a candle. In this instance the walls or sidewalls of the candle top and reshaper unit have the same shape as the reshaper sidewalls 14 of the candle top assembly 2. The candle top and reshaper unit is used to reshape the softened wax at the rim of a candle to move the softened wax inward or downward to prolong the burning life of the candle. The candle top and reshaper unit can then be left on the candle to provide decorative appeal to the candle at rest or not in use.

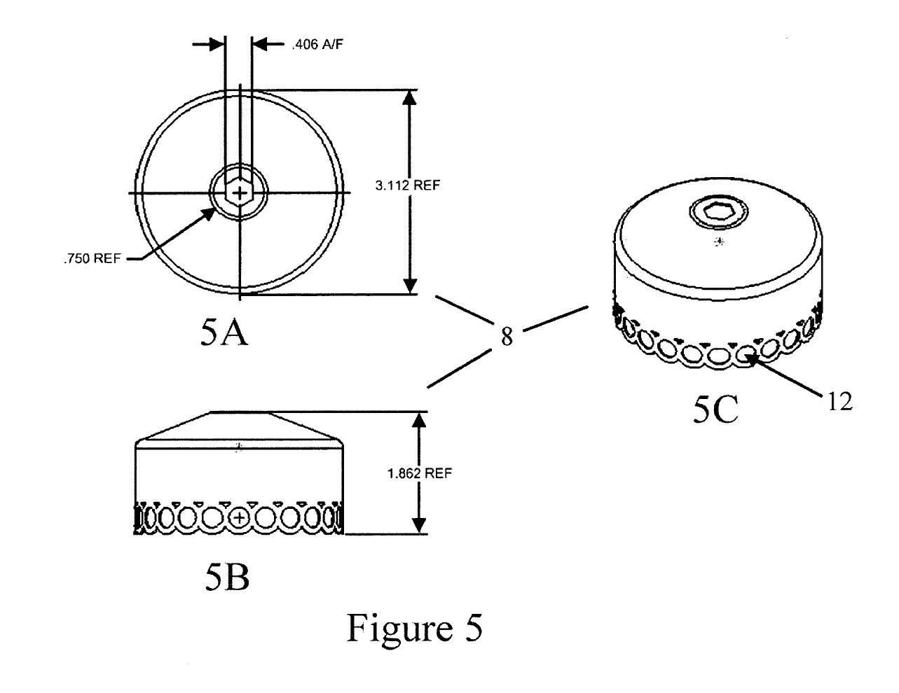

For cost savings, however, in the preferred embodiment as depicted in the figures, the top assembly 2 is manufactured in distinct pieces. For example the decorative housing 8, seen in FIG. 5, may be cut from a single piece of material and shaped appropriately for the candle size and shape or it may be molded such as is done with plastic. The lid 6 may be similarly manufactured and attached to the decorative housing 8 with a weld or other means appropriate to the material or materials being used.

The distinct pieces of the top assembly 2, namely the reshaper 10 depicted in FIGS. 3 and 4; the decorative housing 8, depicted in FIG. 5; and, the lid 6, depicted in FIG. 6 are secured together by a threaded post 7 and securing nut 5 attachment. The threaded post 7, formed as part of the finial 4, is inserted through the central apertures of the lid 6 and decorative housing 8 and threads into the securing nut 5 wherein the securing nut 5 is welded to the reshaper 10.

To achieve the advantages described herein, it is important to regularly and properly reshape the candle with the reshaper 10. It is desirable to reshape a candle when the sides near the rim are softened. To reshape a candle the candle top assembly 2, with the candle reshaper 10 within, is fitted over the burning candle and gentle pressure is applied until reasonable resistance is felt. A rocking motion may also be applied. The applied gentle pressure forces the sidewalls 14 of the reshaper 10 to squeeze the softened candle rim 210 inwardly toward the wick. When the top 16 of the reshaper 10 contacts the rim 210 the softened wax is forced downward. The inward force followed by the downward force folds the softened wax inward to a closer proximity to the wick, adding it to the wax available for burning and thus extending the burn time of the candle. Further, the downward force, when applied evenly, will even out the irregular shape of the rim 210 and improve the appearance of the candle 200. The reshaper 10 is to be left on the candle until the softened wax hardens. In this manner a light seal is formed between the reshaper 10 and the candle 200 at the point where the reshaper sidewall 14 meets the candle rim. In an alternative embodiment where the reshaper sidewall 14 is vertical, the light seal is formed where the reshaper top 16 meets the candle rim. Keeping the reshaper 10 in place will prevent wax from spilling when the candle is moved.

When the reshaper 10 is used, the flame of the candle is extinguished, as little oxygen is available under the reshaper 10. It is preferable to extinguish a candle in this manner as it prevents liquefied wax from being blown onto other surfaces. After extinguishing the flame of the candle, the candle may be safely moved from one location to another without spilling of the hot and liquefied wax. The added weight of the candle top assembly 2, and the formed seal, holds the reshaper 10 and top assembly 2 securely in place over the candle.

For candles with domed tops as opposed to flatter or concave tops it is important to burn the candle until the dome shape is almost gone and the sides are softened. In this manner the sidewalls 14 of the reshaper 10 will contact the softened sides of the candle before the top 16 of the reshaper 10 contacts the top surface providing for proper reshaping of the candle top.

To remove the reshaper 10 and candle top assembly 2 the finial 4 is grasped and gently tugged with an upward motion. Alternatively if no finial 4 is used, the top assembly 2 may be grasped and tugged off in a similar fashion. The top assembly 2 is kept cooler than the reshaper 10 as it is farther removed from the candle and can be handled without fear of being exposed to too much heat.

When a candle is not being used, the top assembly 2 provides for a decorative cover for the candle and protects the soft and liquid wax from collecting dust and insects. It also provides curious children protection from the liquefied wax.

The embodiment of the invention described above is intended to be exemplary only. The scope of the invention is therefore intended to be limited solely by the scope of the appended claims.

We claim:

1. A candle reshaper for shaping the heat softened wax at the rim of a candle, the candle including a central wick and having a size and shape, the candle reshaper comprising;
a body including at least one sidewall and a top, the sidewall and top defining a hollow;
the body shaped to accept within the hollow the size and shape of the candle;
the top including a substantially flat perimeter portion, the flat perimeter portion having a size substantially similar to the size of the candle;
wherein when the reshaper is placed over the candle and pushed downward, the flat perimeter portion contacts the softened wax at the rim and the wax is forced downward and inward toward the wick.

2. A candle reshaper according to claim 1 wherein the size of the body and of the candle is a diameter.

3. A candle reshaper according to claim 2 wherein the diameter of the body is slightly more than three inches.

4. A candle reshaper according to claim 2 wherein the diameter of the body is no larger than ten percent of the diameter of the candle.

5. A candle reshaper according to claim 2 wherein the top portion has a diameter between five and eighteen percent less than the diameter of the candle.

6. A candle reshaper according to claim 1 wherein the shape of the candle is round and the shape of the sidewall is annular.

7. A candle reshaper according to claims 1 wherein the at least one sidewall is perpendicular to the top.

8. A candle reshaper according to claims 1 wherein the at least one sidewall is angled outward from the hollow.

9. A candle reshaper according to claim 7 wherein the at least one sidewall forms a straight taper.

10. A candle reshaper according to claim 7 wherein the at least one sidewall is convex to the hollow.

11. A candle reshaper according to claim 7 wherein the at least one sidewall is concave to the hollow.

12. A candle reshaper for shaping the heat softened wax at a rim of a candle, the candle including a central wick and having a size and shape, the candle reshaper comprising;
a body including at least one sidewall, the sidewall defining a hollow;
the body shaped to accept within the hollow the size and shape of the candle, the body further having first and second opposing ends;
the second end having a larger perimeter than the first end and having a size substantially similar to the size of the candle;
the first end defining an aperture;
wherein when the second end of the body is placed over the candle and pushed downward, the sidewall contacts the softened wax at the rim and the wax is forced inward toward the wick.

13. A candle reshaper according to claim 12 wherein the size of the candle and second end is a diameter.

14. A candle reshaper according to claim 12 wherein the first end of the body has a diameter between five and eighteen percent less than the diameter of the candle.

15. A candle reshaper according to claims 12 further including a top assembly, the top assembly having an interior portion and including securing means for securing the body to the top assembly within the interior portion.

16. A candle reshaper according to claim 15 wherein the top assembly comprises:
a housing member, having an interior portion shaped to receive and secure the body;
a lid member, the lid member fitting on top of the housing member, to substantially cover the housing member; and
securing means for securing the lid member onto the housing member.

17. A candle reshaper according to claim 16 wherein the top assembly further includes a finial positioned above and central to the lid member and securing means for securing the finial to the top assembly.

18. A candle reshaper according to claim 17 further comprising:
the housing member and lid member having co-located central apertures;
the finial including a top and a bottom and a threaded post, the bottom of the finial resting on the lid member and the post protruding from the co-located central aperture;
a nut having a central aperture;
wherein the securing means comprises threading the threaded post into the nut.

19. A candle reshaper according to claim 16 wherein the housing member or lid member includes a decorative design.

20. A candle reshaper for shaping the heat softened wax at the rim of a candle, the candle including a central wick and having a spatial dimension, the candle reshaper comprising:
a body including at least one sidewall and a top, the sidewall and top defining a hollow and said top including a substantially flat perimeter portion;
the body shaped to accept the candle within the hollow, the body further having a proximal end near the top and a distal end away from the top;
the distal end having a dimension substantially similar to the dimension of the candle and the proximal end having a dimension five to eighteen percent less than the dimension of the distal end;
wherein when the distal end of the body is placed over the candle and the proximal end approaches the candle, the at least one sidewall will contact the softened wax at the candle rim and force the wax inward and then the top will contact the softened wax at the candle rim and force the wax downward reshaping the candle.

21. A candle reshaper according to claim 20 wherein the shape of the at least one sidewall is annular.

22. A candle reshaper according to claim 20 wherein the body has three or four sidewalls.

23. A candle reshaper for shaping the heat softened wax at the rim of a candle, the candle including a central wick and having a perimeter, the candle reshaper comprising;
a body including at least one sidewall and a top, the sidewall and top defining a hollow;
the top including a substantially flat perimeter portion;
the body shaped to accept the candle within the hollow, the body further having a perimeter substantially similar to the perimeter of the candle;
the at least one sidewall having a proximal end adjacent to the top and a distal end positioned away from the top, the at least one sidewall forming a larger perimeter at the distal end than at the proximal end;
wherein when the reshaper is placed over the candle and pushed downward, the sidewall contacts the softened wax at the rim and the wax is forced inward toward the wick.

24. A candle reshaper according to claim 23 wherein the flat perimeter portion meets the candle rim and forces the softened wax down and reshapes the rim.

25. A liquefied wax protective cover for a candle, the candle including a softened rim, the cover comprising:
a body including at least one sidewall and a top, the sidewall and top defining a hollow;
the body shaped to accept the candle within the hollow, the body further having a perimeter substantially similar to the perimeter of the candle;
a lid member, the lid member fitting on top of the body, to substantially cover the body; and
securing means for securing the lid member to the body;
wherein when the body is placed over the candle, the at least one sidewall or the top contacts the softened rim of the candle and forms a seal, sealing in the liquefied wax and permitting the candle to be moved immediately after extinguishing.

26. A candle cover according to claim 25 further including a finial positioned above and central to the lid member and joining means for securing the finial to the lid member.

27. A candle cover according to claim 26 wherein the joining means is a means for removably joining.

28. A candle cover according to claim 27 wherein the removably joining means is a threaded screw and nut.

29. A candle cover according to claim 26 wherein the joining means is a means for permanently joining.

30. A candle cover according to claim 29 where the permanently joining means is a weld.

31. A method for increasing a candle burning time comprising the steps of covering a candle with a candle reshaper; and pushing downward said reshaper so as to force inward a softened wax at the rim of said candle toward the candle's wick; said reshaper comprising a body having a sidewall defining a hollow and shaped to accept said candle within the hollow.

32. A decorative assembly for a candle comprising:
a housing member having at least one side, the at least one side defining a hollow;
a lid member, the lid member having a central portion and fitting on top of the housing member, to substantially cover the housing member; and
securing means to secure the lid member to the housing member;
the housing member and lid member fitting over a candle when the candle is not in use providing for a decorative cover.

33. A decorative assembly for a candle according to claim 32 further including a finial positioned above and central to the lid member and securing means for securing the finial to the top assembly.

34. A decorative assembly for a candle according to claim 32 further including a reshaper for reshaping the softened wax at the rim of a candle, the reshaper comprising;
a body including at least one sidewall and a top, the sidewall and top defining a hollow;
the body shaped to accept the candle within the hollow, the body further having a perimeter substantially similar to the perimeter of the candle;
the at least one sidewall having a proximal end adjacent to the top and a distal end positioned away from the top, the at least one sidewall forming a larger perimeter at the distal end than at the proximal end;
wherein when the reshaper is placed over the candle and pushed downward, the sidewall contacts the softened wax at the rim and the wax is forced inward toward the wick.

35. A decorative assembly for a candle according to claim 32 further including a base assembly.
